(19) United States
(12) Patent Application Publication
(10) Pub. No.: US 2024/0287953 A1
(43) Pub. Date: Aug. 29, 2024

(54) INSTRUMENT GAS CAPTURE SYSTEM

(71) Applicant: J-W Power Company, Addison, TX (US)

(72) Inventors: Cole Paul Garner, Hallsville, TX (US); Mark Davis, Henderson, TX (US); Ross Powell, Hallsville, TX (US); Khalil Waleed Fathe Dabbagh, Gladewater, TX (US)

(21) Appl. No.: 18/589,211

(22) Filed: Feb. 27, 2024

Related U.S. Application Data
(60) Provisional application No. 63/487,254, filed on Feb. 27, 2023.

(51) Int. Cl. F02M 21/02; F17C 5/06

(52) U.S. Cl. CPC F02M 21/0233; F02M 21/0215; F17C 5/06; F17C 2221/033; F17C 2227/0157

(57) ABSTRACT

A system includes a gas actuated device and the gas actuated device is configured to receive and release gas associated with actuating the gas actuated device. An actuation gas return path is associated gas actuated device and the actuation gas return is path configured to not vent to atmosphere. A method of reducing gas emissions includes providing a first compressor, operating a gas actuated device using actuation gas, and reusing the actuation gas instead of venting the actuation gas to atmosphere or environment.

### CROSS-REFERENCE TO RELATED APPLICATIONS

This application claims the benefit of U.S. Provisional Patent Application No. 63/487,254, filed 27 Feb. 2023, which is incorporated by reference herein in its entirety.

### STATEMENT REGARDING FEDERALLY SPONSORED RESEARCH OR DEVELOPMENT

Not applicable.

### BACKGROUND

In order to operate a compressor or other equipment, valves and other equipment needs to be actuated. This may be dump valves, block valves, controllers, louver actuators, etc. In the oil and gas industry, it is common to have “high” pressure gas readily available. Many of these devices can be run with a pneumatic signal from 30-80 psig. It has been customary to use natural gas from the fuel system or the process system to actuate these valves. In conventional systems, the gas used to actuate the valves is vented to atmosphere. It is the differential pressure (the 30-80 psig relative to atmospheric pressure) that creates the motive force to move the valve or actuator.

As there are growing concerns about emitting methane (and other gases) into the atmosphere, a way to actuate the valves without emitting them to the atmosphere is desired. In some conventional systems, an air compressor is supplied, and then the pneumatic system can utilize air for actuating valves and in some cases, for both control signaling and actuation of valves. While the fully pneumatic systems do not emit gasses of concern to the atmosphere, there are many locations and circumstances that preclude use or access to utility power so that providing an air compressor can be cost prohibitive.

### BRIEF DESCRIPTION OF THE DRAWINGS

Prior Art FIG. 1 is a schematic view of a natural gas system.

FIG. 2 is a schematic view of a natural gas system according to an embodiment of this disclosure.

FIG. 3 is a schematic view of a natural gas system according to another embodiment of this disclosure.

FIG. 4 is a schematic view of a natural gas system according to another embodiment of this disclosure.

FIG. 5 is a schematic view of a natural gas system according to another embodiment of this disclosure.

FIG. 6 is a schematic view of a valve according to an embodiment of this disclosure.

FIG. 7 is a schematic view of a natural gas system according to another embodiment of this disclosure.

FIG. 8 is a schematic view of a natural gas system according to another embodiment of this disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure divulges systems and methods for actuating valves using natural gas (or other gases) to provide a motive force but without venting the used natural gas to the surrounding environment. Instead, the systems and methods disclosed herein capture, maintain control of, or otherwise manage the used gases in a way that prevents their escape to the environment.

Referring now to Prior Art FIG. 1, a conventional system 100 is shown. System 100 comprises a natural gas supply 102, a vessel 104, a gas compressor 106 for compressing natural gas, and a driver 108 for driving the compressor 106. In this embodiment, the driver 108 comprises an combustion engine configured for being powered by burning natural gas from a natural gas fuel supply 110. In this conventional system, an instrument 112 can be actuated using natural gas and the natural gas utilized in the actuation of instrument 112 is vented to the atmosphere or environment through vent 114. The overall system 100 further comprises a suction input 116 and a discharge output 118.

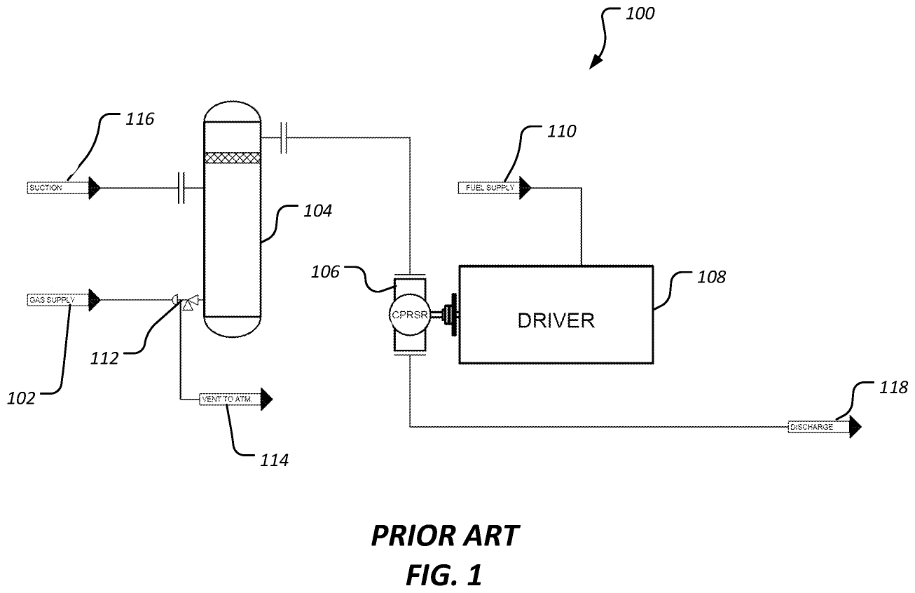

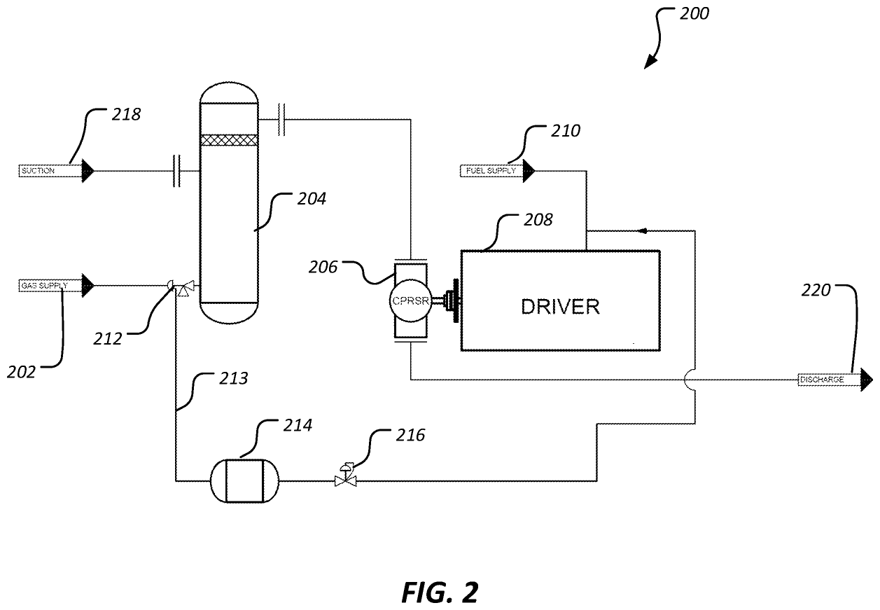

Referring now to FIG. 2, a system 200 according to an embodiment of this disclosure is shown. System 200 comprises a natural gas supply 202, a vessel 204, a gas compressor 206 for compressing natural gas, and a driver 208 for driving the compressor 206. In this embodiment, the driver 208 comprises an combustion engine configured for being powered by burning natural gas from a natural gas fuel supply 210. In this system, an instrument 212 can be actuated using natural gas, however, unlike the system 100, the natural gas utilized in the actuation of instrument 212 is not vented to the atmosphere or environment. Instead, the natural gas utilized to actuate instrument 212 is fed the driver as fuel via a collection tank 214 and a regulator 216. The overall system 200 further comprises a suction input 218 and a discharge output 220.

In alternative embodiments, collection tank 214 can receive natural gas from other and/or additional natural gas actuated instruments, such as, but not limited to, natural gas actuated valves disposed elsewhere in along a flow path of natural gas in system 200, or even from natural gas actuated valves disposed along a flow path of natural gas in a different but substantially collocated system. In this embodiment, the natural gas is fed into the fuel supply 210 and is used to supplement the fuel being used by the driver 208.

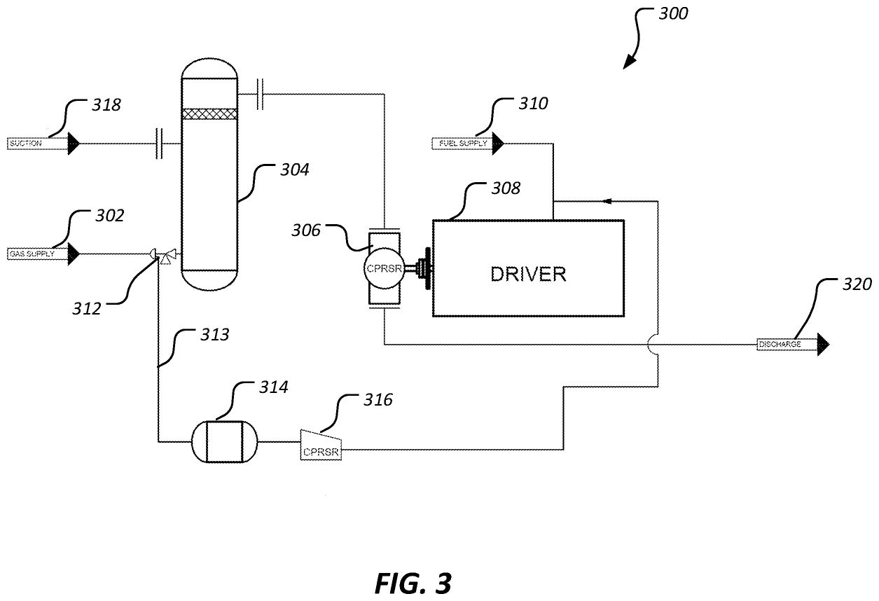

Referring now to FIG. 3, a system 300 according to an embodiment of this disclosure is shown. System 300 comprises a natural gas supply 302, a vessel 304, a gas compressor 306 for compressing natural gas, and a driver 308 for driving the compressor 306. In this embodiment, the driver 308 comprises a combustion engine configured for being powered by burning natural gas from a natural gas fuel supply 310. In this system, an instrument 312 can be actuated using natural gas, however, unlike the system 100, the natural gas utilized in the actuation of instrument 312 is not vented to the atmosphere or environment. Instead, the natural gas utilized to actuate instrument 312 is fed the driver as fuel via a collection tank 314 and a natural gas collection compressor 316. In this embodiment, the collection compressor 316 is used to raise the pressure of recaptured natural gas to pressure higher than the pressure of the fuel supply 310 so that the natural gas fed from the collection tank can be fed to the driver 308. The overall system 300 further comprises a suction input 318 and a discharge output 320.

In alternative embodiments, collection tank 314 can receive natural gas from other and/or additional natural gas actuated instruments, such as, but not limited to, natural gas actuated valves disposed elsewhere in along a flow path of natural gas in system 300, or even from natural gas actuated valves disposed along a flow path of natural gas in a different but substantially collocated system. In this embodiment, the natural gas is fed into the fuel supply 310 and is used to supplement the fuel being used by the driver 308.

It will be noted that in alternative embodiments, in addition to or instead of utilizing a compressor 316, the gas supply 302 pressure can be raised.

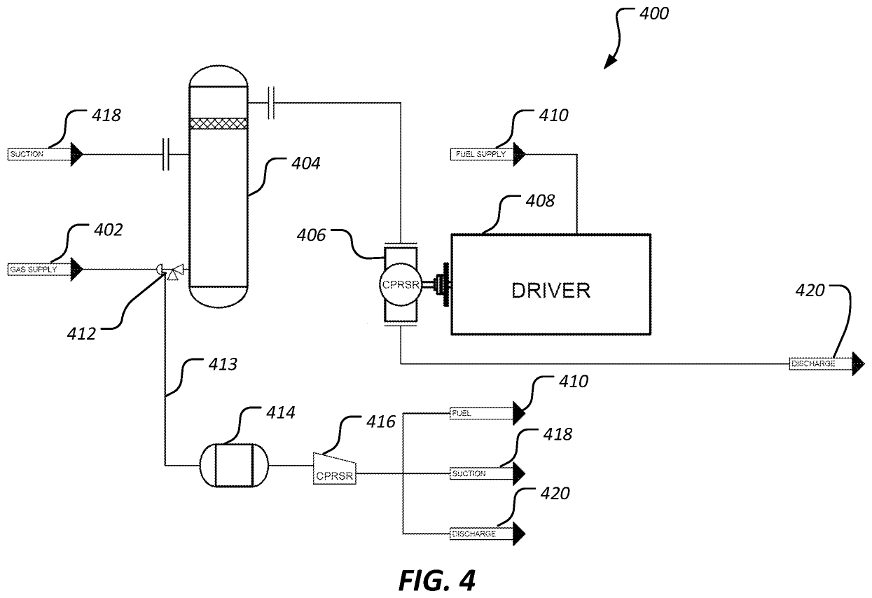

Referring now to FIG. 4, a system 400 according to an embodiment of this disclosure is shown. System 400 comprises a natural gas supply 402, a vessel 404, a gas compressor 406 for compressing natural gas, and a driver 408 for driving the compressor 406. In this embodiment, the driver 408 comprises a combustion engine configured for being powered by burning natural gas from a natural gas fuel supply 410. In this system, an instrument 412 can be actuated using natural gas, however, unlike the system 100, the natural gas utilized in the actuation of instrument 412 is not vented to the atmosphere or environment. Instead, the natural gas utilized to actuate instrument 412 is recaptured and repurposed via a collection tank 414 and a natural gas collection compressor 416. In this embodiment, the collection compressor 416 is used to raise the pressure of recaptured natural gas to pressure higher than the pressure of at least one of the fuel supply 410, a suction input 418 of system 400, and/or a discharge output 420 of system 400.

In alternative embodiments, collection tank 414 can receive natural gas from other and/or additional natural gas actuated instruments, such as, but not limited to, natural gas actuated valves disposed elsewhere in along a flow path of natural gas in system 400, or even from natural gas actuated valves disposed along a flow path of natural gas in a different but substantially collocated system.

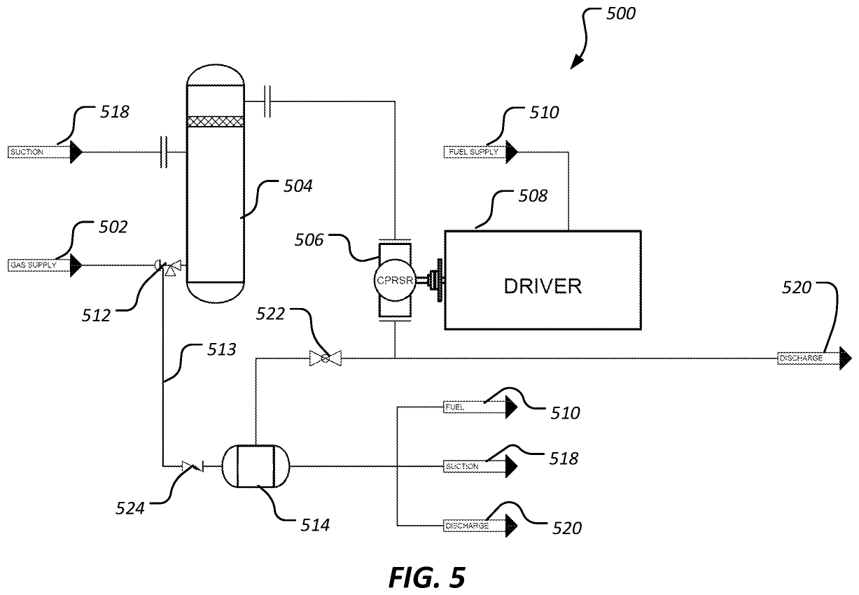

Referring now to FIG. 5, a system 500 according to an embodiment of this disclosure is shown. System 500 comprises a natural gas supply 502, a vessel 504, a gas compressor 506 for compressing natural gas, and a driver 508 for driving the compressor 506. In this embodiment, the driver 508 comprises a combustion engine configured for being powered by burning natural gas from a natural gas fuel supply 510. In this system, an instrument 512 can be actuated using natural gas, however, unlike the system 100, the natural gas utilized in the actuation of instrument 512 is not vented to the atmosphere or environment. Instead, the natural gas utilized to actuate instrument 512 is recaptured and repurposed via a collection tank 514. In this embodiment, the recaptured gas can be supplied to one or more of the fuel supply 510, a suction input 518 of system 500, and/or a discharge output 520 of system 500.

Furthermore, in this embodiment, natural gas emissions from the compressor 506 can be recaptured to collection tank 514 via a blowdown valve 522. In this embodiment, a check valve 524 between collection tank 514 and instrument 512 prevents higher pressure natural gas from compressor 506 migrating toward gas supply 502 or vessel 504. In some cases where the gas supply 502 pressure can be raised, limitations may exist due to the available gas supply pressure, the rating of the valves to be actuated, and the pressure of the system to which the gas will be reinjected.

Providing this recapture capability allows removal of gas from compressor 506 prior to maintenance and without venting the gas of the compressor 506 to the environment or atmosphere.

In alternative embodiments, collection tank 514 can receive natural gas from other and/or additional natural gas actuated instruments, such as, but not limited to, natural gas actuated valves disposed elsewhere in along a flow path of natural gas in system 500, or even from natural gas actuated valves disposed along a flow path of natural gas in a different but substantially collocated system.

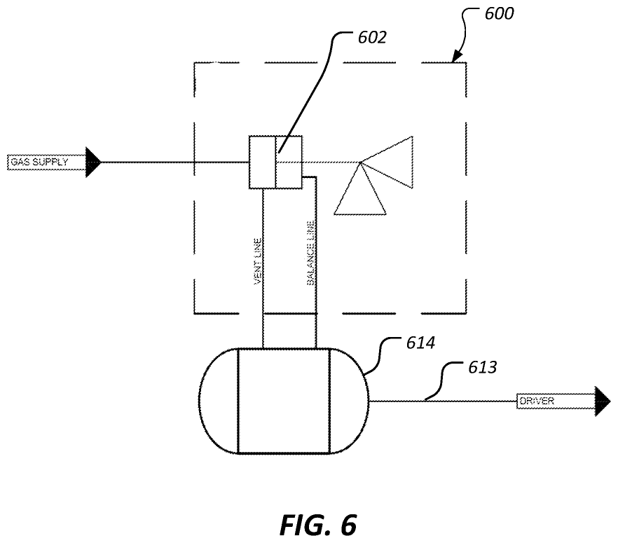

Conventional valves are limited in functionality because they utilize single acting/spring return. In other words, in conventional valves, the natural gas is only acting on one side of a diaphragm/piston. In these cases, to return the valve to a closed/shelf state, the valve must have the pressure removed from the actuator (return to atmospheric pressure). Having the pressure removed does not leave any differential pressure to inject natural gas back into an existing system as desired by the embodiments disclosed herein. Referring now to FIG. 6, a valve 600 is provided to overcome the above-described limitation and valve 600 is configured to allow a downstream side of the diaphragm/piston 602 to be pressured up to the collection tank 614 pressure. This will equalize the pressure across the actuator (in a shelf state) at the collection tank 614 pressure, not atmospheric pressure. Therefore, there will be sufficient pressure to move the natural gas used for actuation into the collection tank 614.

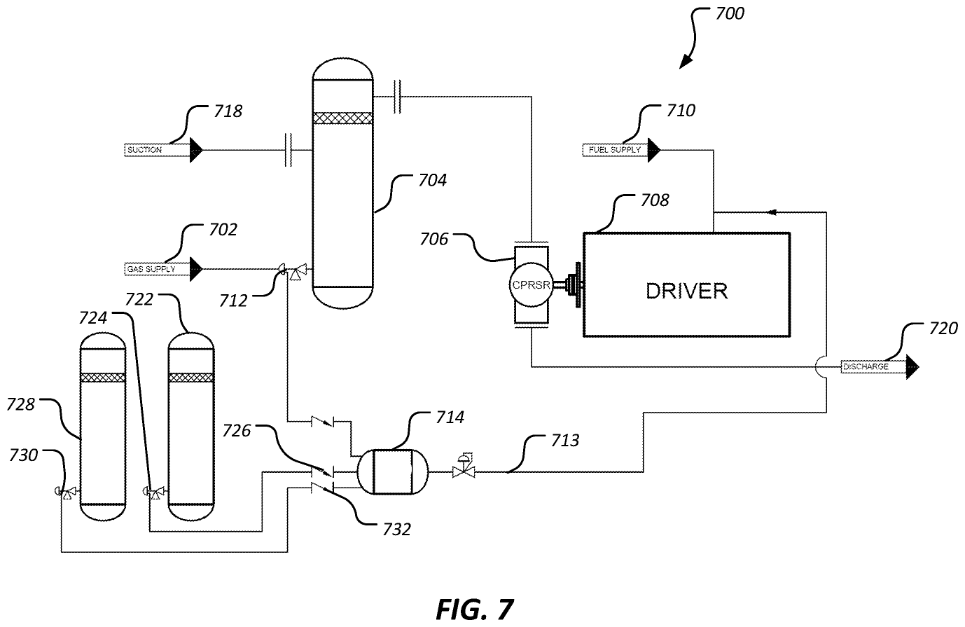

Referring now to FIG. 7, a system 700 according to an embodiment of this disclosure is shown. System 700 comprises a natural gas supply 702, a vessel 704, a gas compressor 706 for compressing natural gas, and a driver 708 for driving the compressor 706. In this embodiment, the driver 708 comprises a combustion engine configured for being powered by burning natural gas from a natural gas fuel supply 710. In this system, an instrument 712 can be actuated using natural gas, however, unlike the system 100, the natural gas utilized in the actuation of instrument 712 is not vented to the atmosphere or environment. Instead, the natural gas utilized to actuate instrument 712 is recaptured and repurposed via a collection tank 714. In this embodiment, natural gas from the collection tank is fed from the collection tank 714 to the fuel supply 710.

In this embodiment, collection tank 714 can receive natural gas from other sources and/or additional natural gas actuated instruments, such as, but not limited to, natural gas actuated valves disposed elsewhere in along a flow path of natural gas in system 700, or even from natural gas actuated valves disposed along a flow path of natural gas in a different but substantially collocated system. In this embodiment, a first alternative vessel 722 is supplied to collection tank 714 via a first alternative instrument 724 and a first alternative source check valve 726 and similarly a second alternative vessel 728 is supplied to collection tank 714 via a second alternative instrument 730 a second alternative source check valve 732. System 700 generally further comprises a suction input 718 and a discharge output 720. A check valve 734 is also provided between collection tank 714 and instrument 712.

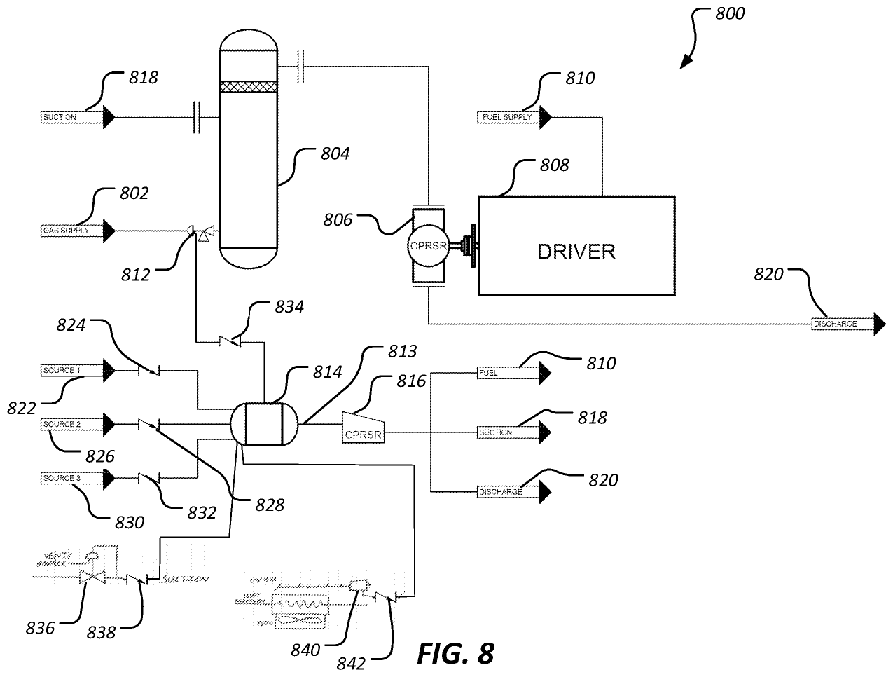

Referring now to FIG. 8, a system 800 according to an embodiment of this disclosure is shown. System 800 comprises a natural gas supply 802, a vessel 804, a gas compressor 806 for compressing natural gas, and a driver 808 for driving the compressor 806. In this embodiment, the driver 808 comprises a combustion engine configured for being powered by burning natural gas from a natural gas fuel supply 810. In this system, an instrument 812 can be actuated using natural gas, however, unlike the system 100, the natural gas utilized in the actuation of instrument 812 is not vented to the atmosphere or environment. Instead, the natural gas utilized to actuate instrument 812 is recaptured and repurposed via a collection tank 814 and a natural gas collection compressor 816. In this embodiment, the collection compressor 816 is used to raise the pressure of recaptured natural gas to pressure higher than the pressure of at least one of the fuel supply 810, a suction input 818 of system 800, and/or a discharge output 820 of system 800.

In this embodiment, collection tank 814 can receive natural gas from other sources and/or additional natural gas actuated instruments, such as, but not limited to, natural gas actuated valves disposed elsewhere in along a flow path of natural gas in system 800, or even from natural gas actuated valves disposed along a flow path of natural gas in a different but substantially collocated system. In this embodiment, a first alternative natural gas source 822 is supplied to collection tank 814 via a first alternative source check valve 824, a second alternative natural gas source 826 is supplied to collection tank 814 via a second alternative source check valve 828, and a third alternative natural gas source 830 is supplied to collection tank 814 via a third alternative source check valve 832. Further, a check valve 834 is disposed between the collection tank 814 and the instrument 812. Still further, in some embodiments, a suction control valve 836 can be utilized upstream of a check valve 838 and gas from the suction control valve 836 can be delivered to the actuation gas return path 813 rather than being vented to atmosphere. Similarly, a gas actuated louver control actuator 840 can be utilized upstream of a check valve 842 and gas from the louver control actuator 840 can be delivered to the actuation gas return path 813 rather than being vented to atmosphere.

It will be appreciated that one or more of the systems disclosed herein can operate generally with suction pressures ranging from about 0-1000 psi, discharge pressures ranging from about 100-4000 psi, fuel supply pressures ranging from 10-80 psi, and gas actuated valves and/or sources ranging from 0-150 psi. These pressures are only one example of pressure ranges one or more of systems 200, 300, 400, 500, 600, 700, and/or 800 can be caused to operate. Still further, it will be appreciated that actuation gas return paths 213, 313, 413, 513, 613, 713, and 813 receive gas associated with actuation gas previously used to selectively actuate a gas actuated device or instrument and the gas return paths are configured to route the actuation gas for use other than venting to atmosphere or the environment.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A system, comprising:
a gas actuated device, the gas actuated device configured to receive and release gas associated with actuating the gas actuated device; and
an actuation gas return path is associated with the outlet, wherein the actuation gas return path is configured to not vent to atmosphere or the environment.

2. The system of claim 1, wherein the system further comprises:
a driver configured to operate by combusting the gas, wherein actuation gas is provided from the actuation gas return path to the driver.

3. The system of claim 2, further comprising:
a collection tank disposed in fluid communication with the actuation gas return path and between the gas actuated device and the driver.

4. The system of claim 3, further comprising:
a regulator disposed in fluid communication with the actuation gas return path and between the gas actuated device and the driver.

5. The system of claim 4, further comprising:
a collection tank disposed in fluid communication with the actuation gas return path and between the gas actuated device and the regulator.

6. The system of claim 2, further comprising:
a compressor disposed in fluid communication with the actuation gas return path and between the gas actuated device and the driver.

7. The system of claim 1, further comprising a gas supply of about 10 psi to about 80 psi.

8. The system of claim 1, further comprising:
at least one of a discharge having a pressure of about 100 psi to about 4000 psi and a suction having a pressure of about 0 psi to about 1000 psi.

9. The system of claim 1, wherein the actuation gas return path feeds actuation gas to a suction of a compressor.

10. The system of claim 1, wherein the actuation gas return path feeds actuation gas to a discharge of a compressor.

11. A method of reducing gas emissions, comprising:
providing a first compressor;
operating a gas actuated device using actuation gas; and
reusing the actuation gas instead of venting the actuation gas to atmosphere or environment.

12. The method of claim 11, wherein reuse comprises combusting the actuation gas to power a driver associated with the first compressor.

13. The method of claim 11, wherein reuse comprises feeding the actuation gas to a suction of the first compressor.

14. The method of claim 11, wherein reuse comprises feeding the actuation gas to a discharge of the first compressor.

15. The method of claim 11, wherein reuse comprises passing the actuation gas into a collection tank.

16. The method of claim 11, wherein reuse comprises passing the actuation gas through a regulator.

17. The method of claim 11, wherein reuse comprises passing the actuation gas through a check valve.

18. The method of claim 11, further comprising:
passing the actuation gas through a second compressor and thereafter passing the actuation gas to a fuel intake of a driver.

19. The method of claim 11, further comprising:
passing the actuation gas through a second compressor and thereafter passing the gas to a suction intake of the first compressor.

20. The method of claim 11, further comprising:
passing the actuation gas through a second compressor and thereafter passing the actuation gas to a discharge of the first compressor.
